(19) United States
(12) Patent Application Publication
(10) Pub. No.: US 2009/0150561 A1
(43) Pub. Date: Jun. 11, 2009

(54) Modulator timing for quantum key distribution

(75) Inventor: Harry Vig, North Billerica, MA (US)

Correspondence Address: OPTICUS IP LAW, PLLC, 7791 ALISTER MACKENZIE DRIVE, SARASOTA, FL, 34240, US

(73) Assignee: MagiQ Technologies Inc.

(21) Appl. No.: 10/587,676

(22) PCT Filed: Feb. 24, 2005
(86) PCT No.: PCT/US05/06015

§ 371 Date: Jul. 27, 2006

Related U.S. Application Data
(60) Provisional application No. 60/549,356, filed on Mar. 2, 2004.

(51) Int. Cl. G06F 15/16; H04L 9/00; H04L 9/08

(52) U.S. Cl. 709/237; 380/256; 380/278

(57) ABSTRACT

Methods for establishing modulator timing for a QKD system (100) having QKD stations (Alice, Bob) with respective modulators (MA, MB) are disclosed. The timing method includes exchanging non-quantum signals (P1, P2) between the two QKD stations and performing respective coarse timing adjustments by scanning the modulator timing domain with relatively coarse timing intervals (ΔT1C, ΔT2C,) and wide (coarse) modulator voltage signals (W1C, W2C). Coarse timings (T1C, T2C) are established by observing a change in detector counts between single-photon detectors (32a, 32b) when modulation occurs in exchanged non-quantum signals. The method also includes performing a fine timing adjustment by scanning the modulator timing domain with respective fine timing intervals (ΔT1R, ΔT2R) and respective relatively narrow modulator voltage signals (W1R, W2R), and again observing a change in detector counts for exchanged non-quantum signals. This operation is repeated until desired final modulator timings (T1F, T2F) and desired final activation signal widths (W1F, W2F) are obtained for the two modulators.

### CLAIM OF PRIORITY

This patent application claims priority from U.S. patent application Ser. No. 60/549,356, filed on Mar. 2, 2004.

### TECHNICAL FIELD OF THE INVENTION

The present invention relates to quantum cryptography, an in particular relates to a method for establishing the timing of the operation of modulators in a quantum key distribution (QKD) system.

### BACKGROUND ART

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals, thus revealing her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in publications by C. H. Bennett et al entitled “Experimental Quantum Cryptography,” J. Cryptology 5: 3-28 (1992), and by C. H. Bennett entitled “Quantum Cryptography Using Any Two Non-Orthogonal States”, Phys. Rev. Lett. 68 2121 (1992), and in U.S. Pat. No. 5,307,410 to Bennett (“the '410 patent”). The general process for performing QKD is described in the book by Bouwmeester et al., “The Physics of Quantum Information,” Springer-Verlag 2001, in Section 2.3, pages 27-33.

The above-mentioned publications and patent by Bennett describe a so-called “one-way” QKD system wherein Alice randomly encodes the polarization or phase of single photons at one end of the system, and Bob randomly measures the polarization or phase of the photons at the other end of the system. The one-way system described in the Bennett 1992 paper is based on two optical fiber Mach-Zehnder interferometers. Respective parts of the interferometric system are accessible by Alice and Bob so that each can control the phase of the interferometer. The interferometers need to be actively stabilized to within a portion of quantum signal wavelength during transmission to compensate for thermal drifts.

U.S. Pat. No. 6,438,234 to Gisin (the '234 patent) discloses a so-called “two-way” QKD system that is autocompensated for polarization and thermal variations by sending the pulses in a round-trip through the interferometer. The optics layer of a two-way QKD system of the '234 patent is thus less susceptible to environmental effects than a one-way system.

One-way and two-way QKD systems such as those described in the '410 patent and the '234 patent are typically described as operating in their ideal operating state without any description of how the ideal state is reached. Further, autocompensation and active stabilization refer to the optics layer of the system and do not apply to setting up the system, or operating the system in an ideal or near-ideal state in combination with all of the other aspects of the QKD system that are not often discussed, such as the electronics and timing systems.

### DISCLOSURE OF THE INVENTION

As described in detail below, first aspect of the invention is a method of setting up the timing for the modulators of a QKD system. A two-way QKD system is considered for the sake of illustration. For a two-way QKD system, the method includes selecting an initial timing, an initial modulation voltage and a relatively large initial modulator voltage signal width for one of the modulators—say, Bob's modulator. The method also includes sending delayed non-quantum pulses from Bob to Alice and receiving the pulses back at Bob without any modulation at Alice's modulator MA. The method further includes counting the pulses that are to be modulated by Bob at Bob's detectors. If no modulation by Bob's modulator occurs, then the method includes iteratively incrementing the modulator activation signal timing by a coarse time interval and observing whether the detectors indicate that modulation has occurred. When modulation occurs, as indicated by a shift in the counts between the detectors, then the voltage timing is reset to a time that yields the change in detector counts. The coarse time interval is then sub-divided into fine time intervals. The modulator activation signal width is reduced, and the timing is adjusted by increments of the fine time interval to further narrow down the precise activation signal timing. This process of iteratively resetting the timing, subdividing the previous time intervals and then incrementing the timing by the new sub-interval is repeated until the final modulator voltage timing T1F is deduced to a desired degree of accuracy. The activation signal timing may ultimately be adjusted along the way to center the modulator activation signal to the arrival of the pulse to be modulated.

Once Bob's timing is established, then Bob's modulator voltage is fixed at and Alice's modulator activation signal is set to provide a select modulation. Also, the modulator signal width for Alice is set to be relatively large and a (new) initial activation signal timing is selected. The iterative process described above for Bob is repeated essentially the same for Alice with respect to the coarse and fine adjustment of the timing and adjusting the modulator activation signal width for Alice's modulator MA to establish a final timing.

In an example embodiment where the QKD system is a two-way system, one of the pulses is modulated both as it enters and as it leaves Alice. This allows for Alice's modulator to modulate the pulse for orthogonal polarizations. Since phase modulators tend to be polarization sensitive, this approach serves to reduce modulation error that results from polarization variations in the pulses.

### BRIEF DESCRIPTION OF THE DRAWINGS

FIG. 1 is a schematic diagram of a two-way QKD system as an example QKD system;

FIG. 2 is a flow diagram of an example embodiment of the method of establishing the modulator timing in the QKD system of FIG. 1 for Bob's modulator; and

FIG. 3 is a flow diagram of an example embodiment of the method of establishing the modulator timing in the QKD system of FIG. 1 for Alice's modulator.

### DETAILED DESCRIPTION OF THE BEST MODE OF THE INVENTION

The present invention relates to and has industrial utility with respect to quantum cryptography, and is directed to systems and methods for performing modulation of quantum signals in a QKD system. The invention is discussed below in connection with a two-way QKD system, though the invention is applicable to both one-way and two-way systems. In the discussion below, a “quantum signal” or “quantum pulse” has an average number of photons μ≦1, and a “non-quantum signal” or “non-quantum pulse” has an average number of photons μ>1.

### Ideal Operation of a Two-Way QKD System

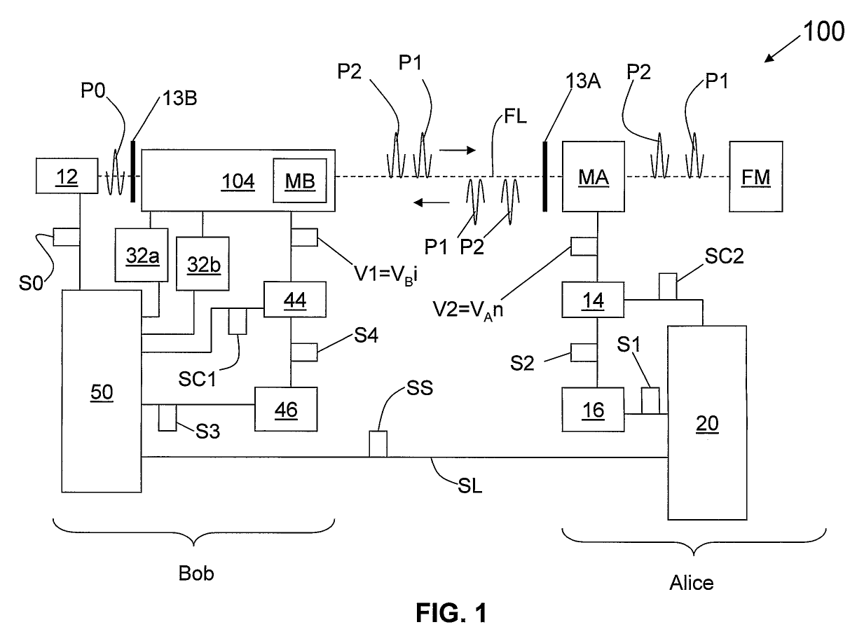

For the sake of illustration, the present invention is described in connection with a two-way QKD system. FIG. 1 is a schematic diagram of a two-way QKD system 100 that includes two QKD stations, Alice and Bob. Bob includes laser 12 that emits light pulses P0. Laser 12 is coupled to a time-multiplexing/demultiplexing (M/D) optical system 104. M/D optical system 104 receives input pulses P0 from laser 12 and splits each pulse into two time-multiplexed pulses (“quantum signals”) P1 and P2. Likewise, M/D optical system 104 receives from Alice (discussed below) pairs of time-multiplexed pulses and combines (interferes) them into a single pulse. M/D optical system 104 includes a phase modulator MB coupled to M/D optical system 104. Optical fiber link FL is coupled to M/D optical system 104 and connects Bob to Alice. Bob also includes a voltage controller 44 coupled to modulator MB, and a random number generator (RNG) unit 46 coupled to the voltage controller.

Bob also includes two detectors 32a and 32b coupled to M/D optical system 104. Bob further includes a controller 50 operatively (e.g., electrically) coupled to laser 12, detectors 32a and 32b, voltage controller 44 and to RNG unit 46.

Alice includes a phase modulator MA coupled at one end to optical fiber link FL and at the opposite end to a Faraday mirror FM. Alice also includes voltage controller 14 coupled to modulator MA, and random number generator (RNG) unit 16 coupled to the voltage controller. Alice further includes controller 20 coupled to RNG unit 16 and to voltage controller 14.

Bob's controller 50 is coupled (optically or electronically) to Alice's controller 20 via synchronization link (channel) SL to synchronize the operation of Alice and Bob. In particular, the operation of the phase modulators MA and MB is coordinated by controllers 20 and 50 exchanging synchronization signals SS over synchronization link SL. In an example embodiment, the operation of the entire QKD system, including the modulator timing set-up of the present invention, is controlled from either controller 20 or controller 50.

### Idealized Operation of Two-Way QKD System

In an example embodiment of the operation of QKD system 100, Bob's controller 50 sends a signal S0 to laser 12, which in response thereto initiates a relatively strong, short laser pulse P0. In an example embodiment, pulse P0 is then attenuated by an optional variable optical attenuator VOA 13B. The pulse P0 arrives at M/D optical system 104, which splits the pulse into two weak pulses, P1 and P2, having orthogonal polarization. Pulse P1 goes directly towards Alice while P2 is delayed. One of pulses P1 and P2—say, P2—is delayed and passes through MB (which remains inactivated at this point), and the pulses travel down the optical fiber link FL to Alice, with one pulse behind the other, e.g., pulse P2 behind pulse P1, as shown.

Note that in another embodiment of system 100, pulses P0 and P1 can be relatively strong pulses that are attenuated by Alice using a VOA 13A located at Alice, wherein the pulses are attenuated to make them weak (quantum) pulses prior to them returning to Bob.

The pulses pass through Alice's modulator MA and reflect off of Faraday mirror FM, which changes the polarization of the pulses by 90°. As the pulses travel back through modulator MA, Alice lets the first pulse P1 pass therethrough unmodulated but modulates the phase (i.e., imparts a phase shift (φ_{A} to) second pulse P2.

At this point, the system acts very much like a one-way system, with Alice modulating a quantum pulse and sending it to Bob, who also modulates the signal and detects it at one of detectors 32a and 32b.

The timing of the modulation for Alice's modulator MA is provided by the synchronization signal SS shared between controllers 20 and 50, as described in greater detail below. The modulation at Alice is carried out by controller 20 providing a well-timed signal S1 to RNG unit 16, which provides a signal S2 representative of a random number to voltage controller 14. In response, voltage controller 14 sends an activation signal (voltage) V2=V_{A} randomly selected from a set of basis signals (voltages), e.g., V[+3π/4], [V−3π/4], V[+π/4], and V[−π/4]. This sets the phase of modulator MA to one of the corresponding basis phases, e.g., +3π/4, −3π/4, π/4 or −π/4.

The two pulses P1 and P2 then travel back to Bob, where, say, pulse P2 passes unaltered through M/D optical system 104, but pulse P1 is delayed and passes through modulator MB, but where modulator MB imparts a phase shift φ_{B} to pulse P1. The timing of the modulation of pulse P1 (or any other selected pulse) at Bob is provided by the synchronization signal SS shared between controllers 20 and 50, as described in greater detail below. The modulation is carried out by controller 50 providing a well-timed signal S3 to RNG unit 46, which provides a signal S4 representative of a random number to voltage controller 44. In response, voltage controller 44 sends a activation signal (voltage) V1=V_{B} randomly selected from a set of basis signals (voltages), e.g., V[+π/4] or V[−π/4]. This sets the phase of modulator MB to one of the corresponding basis phase values, e.g., +π/4 or −π/4.

Further, when pulses P1 and P2 enter M/D optical system 104, pulse P1 is delayed by an equal amount equal to that originally imparted to pulse P2 when the pulses where outgoing from Bob. M/D optical system then interferes pulses P1 and P2 to create an interfered pulse (not shown).

The detectors 32a and 32b are arranged so that constructive interference (φ_{A}−φ_{B}=0) is detected by detector 32a, while destructive interference (φ_{A}−φ_{B}=π) is detected by detector 32b. When Bob imparts the same basis phase as Alice, a count in detector 32a indicates binary 0 and a count in detector 32b indicates binary 1. However, when Bob's basis phase is different from Alice's, there is no correlation and the count winds up in either detector 32a or 32b with equal probability (i.e., interfered the pulse has a 50:50 chance of being detected in either detector).

### Modulator Timing Set-Up

The description above addresses idealized QKD system operation. However, in practice, QKD systems do not automatically remain operating in the ideal state. Further, a commercially realizable system must first be quickly set up to operate and then must be able to compensate for changes in its operating state to ensure ongoing ideal or near-ideal operation.

Accordingly, prior to running a QKD system in the idealized manner described above, the system must first be set up and calibrated to operate properly. This includes calibrating the modulators (phase or polarization) so that the proper modulation is achieved.

However, in order to calibrate the modulators in a QKD system, the proper timing of the activation of the modulators must first be established. Specifically, each modulator must be activated at the precise moment the quantum pulse that needs to be modulated passes through the particular modulator. Minimizing the amount of time a modulator is activated reduces the chances of an eavesdropper determining the modulator state in an attempt to gain information about the exchanged key.

Thus, an example embodiment of the present invention includes setting up the modulator timing. For each modulator, the method includes two main steps: a coarse timing adjustment with a relatively wide modulation activation signal followed by a fine timing adjustment with a narrow modulation activation signal width.

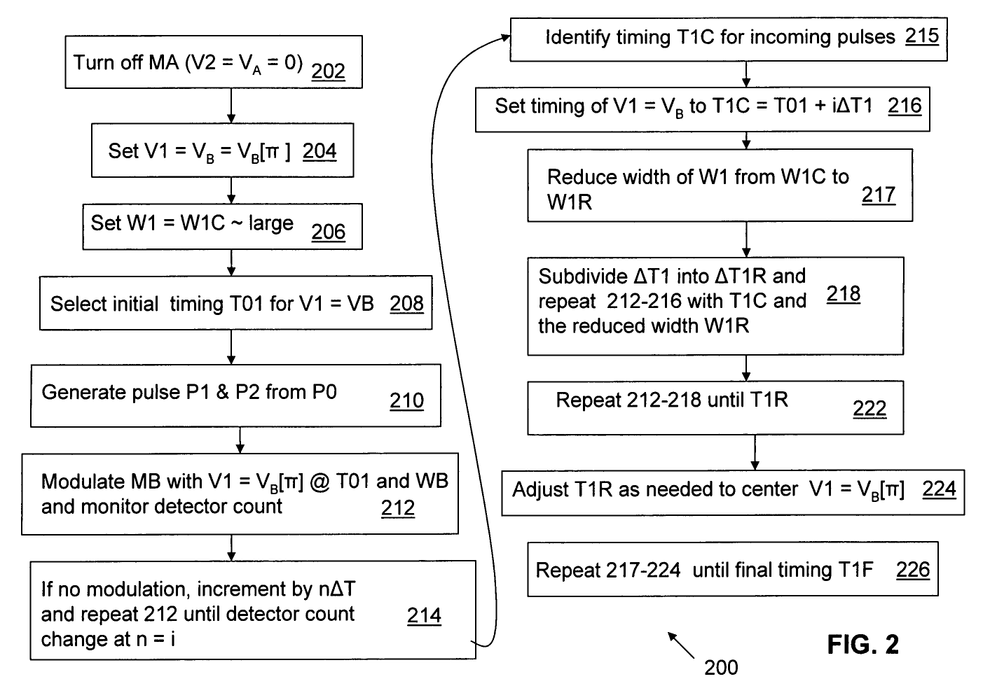

These basic steps are now described in greater detail below with reference to QKD system 100 of FIG. 1 and the flow diagram 200 of FIG. 2. Note that in an example embodiment, controllers 20 and 50 communicate directly with their respective voltage controllers 14 and 44 via respective calibration signals SC1 and SC2 in the modulator timing set-up rather than through RNG units 16 and 46.

### Timing for Bob's Modulator

In an example embodiment, the timing for Bob's modulator MB is established, though Alice's timing could be established first.

With reference to flow diagram 200 of FIG. 2, in 202, Bob's controller 50 sends a signal SS over synchronization channel SL to controller 20 instructing it to turn off Alice's phase modulator if it is not already off. Alice modulator could alternatively be set at a fixed modulation, but it is easier just to leave it off. In this sense, Alice's modulator is said to be at a “fixed modulation,” which includes the case of no modulation when the modulator is inactive.

In 204, controller 50 then directs voltage controller 44 to set the activation signal (voltage) V1=V_{B} for modulator MB to a relatively large modulation value, such as V_{B}[π] to generate a π phase shift. The voltage setting of V_{B}[π] is preferable because it allows for fewer photons (e.g., hundreds) per pulse to be used as compared to other modulation settings that require more (i.e., thousands) of photons per pulse. This translates into a faster scan time and thus faster timing set-up procedure. Thus, even though the particular bases used in the key exchange operation might not include a basis phase setting of π, in an example embodiment, for the purposes of setting up the modulator timing as quick as possible, such a phase setting—i.e., a non-basis phase setting—is used.

In 206, controller 50 also directs voltage controller 44 to make the width of the modulator activation signal V1 to relatively large—say, 50 ns—as compared to the final activation signal width, which is typically in the range from 2 ns to 10 ns. This relatively coarse width is called W1C. In 208, controller 50 selects an initial modulator voltage time T01, at which time activation signal V_{B}[π] is to be applied to modulator MB. In an example embodiment, T01=0.

In 210, controller 50 then sends a signal S0 to laser 12 to generate pulses P0 at a given repetition rate, such as 1 MHz. Pulses P0 need not be quantum pulses and can have, for example, hundreds or thousands of photons. In an example embodiment, pulses P0 are non-quantum pulses so that they having enough photons to readily discern the optical signals detected in detectors 32a and 32b. In such a case, μ is typically between 1 and 10.

In 212, modulator MB is modulated via activation signal V1=V_{B}[π] at time T01 and with width W1C, and the photon count at detectors 32a and 32b is measured. If the timing of modulator MB is not correct, then no pulses will be modulated and the photon count at detector 32a will be high, while the photon count at detector 32b will be low and originating mostly from dark current and other spurious effects.

Note that in system 100 of FIG. 1, two pulses P1 and P2 are created from pulse P0. These pulses are reflected from Alice and return to Bob. In system 100 as described above, the relative phase difference between P1 and P2 at the end of a round trip along optical fiber link FL is measured by detectors 32a and 32b.

In system 100, the phase modulation from modulators MA and MB can be imparted to P1 by both Alice and Bob, imparted to P2 by both Alice and Bob, imparted to P1 by Bob and to P2 by Alice or vice versa, since it is the overall relative phase difference between the pulses that is ultimately measured, not the phase of any particular pulse. However, the particular phase modulation method must be agreed upon in advance by Alice and Bob in order to set the modulator voltage amplitudes and the voltage pulse timing to the correct levels.

In the example embodiment described below, it is presumed for the sake of illustration that pulse P1 is modulated by both Alice and by Bob. The phase shift is the sum given by each modulator, and is compared to the phase of the unmodulated pulse P2. Thus, in an example embodiment of the modulator timing set-up, it is the modulation of pulse P1 through Alice that needs to be timed. If both pulses P1 and P2 are to be modulated, the timing set-up method of the present invention applies to this case in a straightforward manner. For example, if P1 is modulated by Bob and P2 is modulated by Alice, then a modulator activation signal in the form of a bias phase voltage of V_{B}=V_{A}=V[π] needs to be provided to both modulators to ensure a null phase difference.

For the sake of security, it is important that Bob's outgoing pulses P1 and P2 not be modulated because this could reveal information of Bob's modulator state to an eavesdropper. This is particularly true when a high average photon level μ is used, since is allows an eavesdropper to place a tap on the fiber link FL without detection.

After a sufficient sampling interval, resulting in say at least the detection of ten non-quantum signals or more in the presence of external noise, the photon count (i.e., the number of “clicks”) of each detector is recorded, and in 214 the pulse timing T01 (measured, say, at the leading edge of the voltage signal) is incremented by timing interval ΔT1. The value of ΔT1 is selected to be slightly smaller than the initially wide activation signal V1=V_{B}. For example, for a 1 MHz repetition rate from laser 12, the pulses P0 are separated by 1 μs. This interval can be divided, say, into 25 segments, to define a (coarse) time increment ΔT1=40 ns, which can be covered with a 50 ns modulator pulse width to guarantee overlap.

Also in 214, the photon count is checked again to see if modulation has occurred. If not, then T0 is incremented by another ΔT1, etc., and 212 is repeated and the photon count check of 214 is repeated. In an example embodiment, acts 212 and 214 are repeated (iterated) n times for T01+nΔT1 until the entire timing interval (i.e., the timing domain) between successive non-quantum pulses is covered, and then the timing interval that yield a change in detector count is established. In another example embodiment, the iteration stops when the change in detector count is detected.

Note that by setting the modulator activation signal V1 to be V_{B}[π], the shift in photon counts at detectors 32a and 32b is dramatic when the phase modulation finally occurs, as compared to setting the modulator activation signal V1 to V_{B}[π/4], as is the case for normal QKD system operation in establishing a quantum key.

For a two-way QKD system, this process results in two time intervals during which photons are detected on detector 32b rather than detector 32a. One such time interval occurs when photons from laser 12 are modulated by the modulator MB during travel towards Alice and one interval when the photons returning from Alice travel through the modulator MB. If the length of the fiber link FL was changed so that the round trip travel time was increased, then the outgoing pulse would show a modulation at the same point in time, while the return pulse would result in a modulation at a time corresponding to the delay due to the increase in round-trip travel time.

A similar effect can be achieved without changing the physical fiber by changing the rate at which photon pulses P0 are sent in to the system. Since there is more than one pulse in the fiber link FL, this will cause an apparent change in location of the return pulse. Thus, in 215, modulator MB is set to the coarse timing T1C that only modulates pulses incoming to Bob, and that corresponds to the pulses that change locations.

Once the shift in photon counts from one detector to the other occurs so that the outgoing (coarse) activation signal timing T1C is identified, then the process proceeds to 216, wherein the activation signal timing is actually set to T1C. However, the modulation timing at this point is only known to within the timing interval ΔT1, which is initial set to a relatively large value, e.g., 50 ns.

The relatively coarse modulation activation signal width W1C needs to be decreased to a more reasonable value W1R. Ideally, activation signal V1=V_{B} ultimately has a final width W1F that is as small as possible so that modulator MB is activated only for the briefest amount of time necessary to modulate incoming pulse P1. Also, the activation signal width W1=WB needs to be small enough so that incoming pulse P2, which is close to incoming pulse P1 (e.g., within a few nanoseconds), passes through modulator MB without being modulated.

Accordingly, in 217 the activation signal width is reduced, e.g., to W1R=5 ns. This value is picked with physical bandwidth and settling time limitations of the modulator voltage driver 14 in mind. Thus, in 218 the timing interval ΔT1 is divided into a number of reduced-size intervals ΔT1R, for example (50 ns)/(25)=2 ns. This interval should be smaller than the new reduced activation signal width W1R to allow overlap during scanning.

In 222, acts 212-218 are then repeated using the reduced time increment and varying the timing based on the relationship T1R=T1+nΔT1R until the actual value of T1R (the reduced timing) is determined to within ΔT1R (here, ΔT1R=2 ns). In 224, activation timing signal V1 is centered about the interval at which the photon counts at the detectors show a change that indicates modulation by modulator MB.

If necessary, in 226 the process of finding the modulation activation timing T1 and T1R, (optionally) narrowing voltage signal width W1 to a reduced width W1R, and subdividing the time interval ΔT1 into increasingly smaller segments ΔT1R in 217-224 is repeated with even further reduced activation timing signals T1R, correspondingly smaller time intervals, and optionally smaller activation signal widths W1R. The process is repeated until a final timing T1F of the modulator activation signal V1=V_{B} for modulator MB is established to a desired degree of accuracy, e.g., to about 2 ns or so, and until a desired final activation signal width W1F is achieved, e.g., about 2 ns or so.

### Timing for Alice's Modulator

Once the timing of Bob's modulator MB is established, then the timing of Alice's modulation needs to be established.

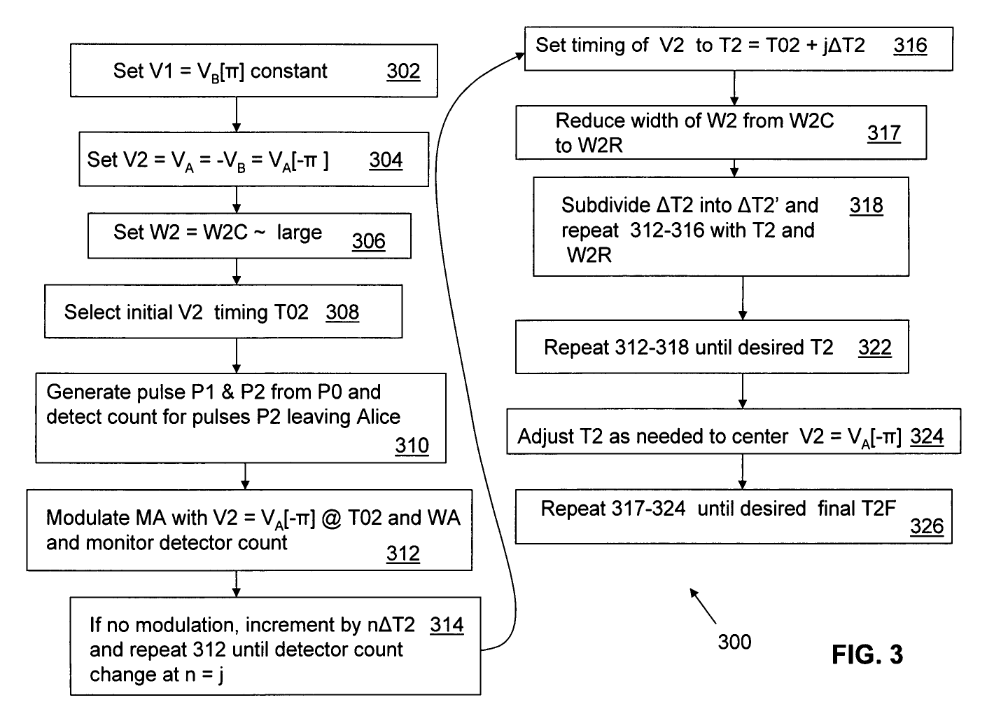

Accordingly, with continuing reference to FIG. 1 and also to the flow diagram 300 of FIG. 3B, in 302 Bob's modulator voltage is set constant at V1=V_{B}[π].

In 304, Alice's controller 20 sends a signal SC2 to voltage controller 14 directing it to send a modulator activation (voltage) signal V2=V_{A}=−V_{B}=V_{A}[−π] to modulator MA. This serves to set the phase of modulator MA to (nominally) −π. Bob's modulator MB is maintained constant at V1=V_{B}[π] during Alice's modulator timing set-up. As with Bob's modulator activation signal V1=V_{B}, Alice's modulator activation signal V_{A} is set to a relatively large modulation value, such as V2=V_{A}[−π] so that if modulation occurs at modulator MA, an overall phase shift of (nominally) 0 causes essentially all of the modulated photons being detected at detector 32a. If no modulation occurs at modulator MA, then the pulses will have a phase of π imparted by modulator MB at Bob, which results in essentially all of the modulated pulses being detected at detector 32b.

In 306, as in 206 for Bob, controller 20 also directs voltage controller 44 to make the width W2=WA of modulator activation signal V2=V_{A}[π] relatively large—say, 50 ns—as compared to the final signal width W2F (which is typically about 10 ns). This relatively large (coarse) width is referred to as W2C.

In 308, as in 208 for Bob, controller 20 selects a (new) initial time T02 at which time modulator activation signal V2=V_{A}[−π] is to be applied to modulator MA.

Note that in an example embodiment, the optical pulse to be modulated at Alice is modulated both on the way in and on the way out of Alice. This requires the activation signal width W2C be wide enough to modulate the pulse as it travels through the modulator to the Faraday mirror and back through the modulator, yet narrow enough not to modulate both pulses P1 and P2. This modulation approach has the advantage of reducing the polarization sensitivity of the modulator to variations in the pulse polarizations.

In 310, as in 210 for Bob, controller 50 then sends a signal S0 to laser 12 to generate pulses P0 at a given repetition rate, such as 1 MHz.

In 312, as in 212 for Bob, the photon count at detectors 32a and 32b is measured. If the timing of modulator MA is incorrect, then pulse P2 passing through the modulator on the way back to Bob will not be modulated at Alice and the photon count at detector 32b will be high, while the photon count at detector 32a will be low and be due mostly to dark current and other spurious effects.

Recall that in system 100 of FIG. 1, two pulses P1 and P2 are created from pulse P0. These pulses are reflected from Alice and return to Bob. In system 100 as described above, either pulse P1 or pulse P2 is modulated by Alice and either pulse P1 or pulse P2 is modulated by Bob. Thus, in the modulator timing set-up for Alice, it is the modulation of previously agreed upon pulse P1 or P2 that needs to be timed, and it needs to be modulated on both the way into Alice and the way out of Alice.

Unlike the situation at Bob, the round trip time for a photon to travel from modulator MA, to the faraday mirror MF, and back to modulator MA is well known as does not change to any appreciable degree. This round trip travel time is smaller than the time separating P1 and P2. Modulator MA is driven with a sufficiently narrow modulator activation signal to observe two changes in photon detector counts: one change corresponding to the transition in and out of P1, and the second change corresponding to the transition out of P2. The modulator activation signal V2 has a width sufficient to cover both directions of travel of P1 or P2 at the same time.

If the photon count indicates no modulation has occurred, then in 314 the initial voltage signal timing T02 is incremented by ΔT2, as in 214 for Bob. The value of ΔT2 is selected, for example, by knowing the time interval between pulses P1 and P2 so as to guarantee that only one pulse is modulated at a time. In 314, the photon count is checked again to see if modulation has occurred. If not, then T02 is incremented by another ΔT2, etc., and photon count check is repeated. This process is repeated n times for T2C=T02+nΔT2 until the entire time interval (domain) between successive pulses is covered. In 316, the value of T2C that results in a change in detector counts is then set to the coarse timing value for modulator MA.

Recall, at Bob only one direction of travel of pulses P1 or P2 is covered by the modulator activation signal V1=V_{B}. However, in Alice, both directions of travel of the pulses are covered by the modulator activation signal V2=V_{A}. Thus, in the case of Bob, a change in photon count of say, less around 50%, would not be wholly indicative of a change in the modulation. On the other hand, such a change at Alice could very well indicate that at least one of the two modulations of the pulse to be modulated has occurred and that at least a rough estimate of the timing has been established.

Once the timing T2 for modulator activation signal V2=V_{A}[−π] is established in 316, then as in 217 of Bob, in 317 the coarse activation signal width W2C is decreased to a smaller (reduced) size W2R to make probing modulator MA by an eavesdropper more difficult. In an example embodiment the activation signal width W2C is made incrementally smaller to form reduced activation signal width W2R, and acts 312-316 are repeated with the smaller signal width.

Then, as in 218 of Bob, in 318 the timing interval ΔT2 is divided into finer (reduced) sub-intervals ΔT2R and in 322 acts 312-317 are repeated. If a change occurs in the photon count that indicates a change back to the “no modulation” state, then in 324, as in 224 for Bob, the modulator voltage timing T2R is adjusted to shift the narrowed voltage signal until modulation is reestablished, and preferably so the narrowed voltage signal is centered on the pulse P2. In 326, acts 317-324 (or 318-324) are then repeated until final desired activation signal timing T2F is established, along with a final desired activation signal width WF. In an example embodiment, Alice's final activation signal width W2F is about 5× of Bob's activation signal W1F, e.g., W1F=2 ns and W2F=10 ns.

In an example embodiment, the modulator timing set-up is accomplished by including software in controllers 20 and 50 that has instructions for carrying out the timing method discussed above and illustrated in the corresponding flow diagrams.

Not also that the modulator timing set-up process must be repeated if the fiber length is changed, (e.g., a connection to a new fiber link FL or optical switching to a new optical path), or if the qbit update rate changes. This is yet another reason why it is important to have such a modulator timing set-up procedure for a commercially viable QKD system.

An advantage of the present invention is that example embodiments of the methods can employ non-quantum signals to calibrate the modulator timing to enable the exchange of quantum signals during the normal operation of the QKD system.

In addition, the method of the present invention can be carried out periodically if the photon count drops during normal operation of the QKD system in order to re-establish the modulator timing, or as a diagnostic to understand if the drop in photon count is due to modulator timing. Period re-timing of the modulators helps ensure that the QKD system operates in an ideal or near-ideal condition.

1. A method of establishing timing for first and second modulators in a quantum key distribution (QKD) system, comprising:
setting the second modulator to a fixed modulation;
incrementally scanning an activation signal for the first modulator over a range of timing values to determine the first modulator activation signal timing based on a change in detector counts of exchanged non-quantum signals;
setting the first modulator to a fixed modulation; and
incrementally scanning an activation signal for the second modulator over a range of timing values to determine the second modulator activation signal timing based on a change in detector counts of exchanged non-quantum signals.

2. The method of claim 1, wherein the QKD system is a two-way system, and the first and second modulators are phase modulators.

3. The method of claim 2, wherein the first modulator is in a first QKD station (Bob) that generates the non-quantum signals, the second modulator is in a reflective QKD station (Alice) that reflects the non-quantum signals back to the first QKD station, and wherein the method further includes:
discerning between two timing intervals associated with non-quantum signals entering and leaving the first QKD station to ensure that only non-quantum or quantum signals entering the first QKD station are modulated by the first modulator.

4. The method of claim 1, wherein the modulator activation signals for the first and second modulators provide respective modulations that result in a maximum change in detector counts when the transmitted non-quantum signals experience a change in modulation.

5. The method of claim 1, wherein the activation signals for the first and second modulators provide respective modulations that are not basis modulations associated with establishing a quantum key.

6. The method of claim 1, wherein the detector counts occur in first and second detectors arranged so that constructively interfered non-quantum signals are detected in the first detector and destructively interfered non-quantum signals are detected in the second detector.

7. The method of claim 1, including for each modulator:
establishing a coarse timing interval;
dividing up the coarse timing interval into a number of sub-intervals; and
incrementally scanning the sub-intervals to establish a more accurate modulator timing.

8. The method of claim 7, including reducing a width of the modulator activation signal for each modulator.

9. A method of establishing timing between two modulators in a QKD system by exchanging non-quantum pulses, the method comprising for each modulator:
a) exchanging non-quantum signals that pass through each modulator;
b) performing a coarse timing adjustment by incrementally scanning a relatively wide modulator activation signal over a range of possible modulator timings to establish a coarse timing value that corresponds to a change in an amount of non-quantum signals detected due to a change in modulation of the non-quantum signal; and
c) performing a fine timing adjustment by incrementally scanning a relatively narrow modulator activation signal over a timing interval centered about the coarse timing value determined in b) to establish a fine timing value that corresponds to a change in an amount of non-quantum signals detected due to a change in modulation of the non-quantum signal.

10. The method of claim 9, wherein the timing interval in c) is the same as the width of the relatively wide activation signal in b).

11. In a quantum key distribution (QKD) system having first and second optically linked QKD stations, a method of establishing timing of first and second modulator activation signals V1 and V2 and for a first modulator MB in the first QKD station Bob and a second modulator MA in the second QKD station Alice, respectively, the method comprising:
a) setting the second modulator MA to a fixed modulation;
b) setting the first activation signal V1 to a relatively large initial width W1C;
c) varying the first activation signal timing in a coarse increment ΔT1 about an initial timing T10 to establish a course timing T1C of the first activation signal by observing a change in detector counts of exchanged non-quantum pulses;
d) setting the first activation signal to a reduced width W1R<W1C
e) varying the first activation signal timing by reduced timing intervals ΔTR<ΔT1 about the coarse timing TC1 to establish a fine timing T1F of the first activation signal by observing a change in detector counts of exchanged non-quantum pulses;
f) setting the first modulator MB to a fixed modulation;
g) setting the second activation signal V2 to a relatively large initial width W2C;
h) varying the second activation signal timing by coarse timing intervals ΔT2 about an initial timing T20 to establish a course timing T2C of the second activation signal by observing a change in detector counts of exchanged non-quantum pulses;
i) setting the second activation signal to reduced width W2R<W2C; and
j) varying the first activation signal timing in reduced timing increments ΔT2R<ΔT2 about the coarse timing TC2 to establish a fine timing T2F of the second activation signal by observing a change in detector counts of exchanged non-quantum pulses

12. The method of claim 11, including setting the first and second modulator activation signals to cause a maximum detector count change when a change in modulation occurs in the exchanged non-quantum pulses.

13. The method according to claim 11, wherein the QKD system is a two-way system with the first QKD as “Bob,” and further including:
discerning between timing intervals associated with pulses entering and leaving the first QKD station to ensure that only quantum pulses that are incoming to the first QKD station are modulated during operation of the QKD system when exchanging quantum pulses to establish a quantum key.
